(19) United States
(12) Patent Application Publication
(10) Pub. No.: US 2015/0160849 A1
(43) Pub. Date: Jun. 11, 2015

(54) Bezel Gesture Techniques

(71) Applicant: Microsoft Corporation, Redmond, WA (US)

(72) Inventors: John G. A. Weiss, Lake Forest Park, WA (US); Catherine N. Boulanger, Kirkland, WA (US); Steven Nabil Bathiche, Kirkland, WA (US); Moshe R. Lutz, Bellevue, WA (US)

(73) Assignee: Microsoft Corporation, Redmond, WA (US)

(21) Appl. No.: 14/099,798

(22) Filed: Dec. 6, 2013

(51) Int. Cl. G06F 3/0488; G06F 3/044

(52) U.S. Cl. CPC G06F 3/04883; G06F 3/044

(57) ABSTRACT

Bezel gesture techniques are described. In one or more implementations, a determination is made that an input involves detection of an object by one or more bezel sensors. The bezel sensors are associated with a display device of a computing device. A location is identified from the input that corresponds to the detection of the object and an item is displayed at a location on the display device that is based at least in part on the identified location.

### BACKGROUND

The amount of functionality that is available from computing devices is ever increasing, such as from mobile devices, game consoles, televisions, set-top boxes, personal computers, and so on. One example of such functionality is the recognition of gestures, which may be performed to initiate corresponding operations of the computing devices.

However, conventional techniques that were employed to support this interaction were often limited in how the gestures were detected, such as to use touchscreen functionality incorporated directly over a display portion a display device. Additionally, these conventional techniques were often static and thus did not address how the computing device was being used. Consequently, even though gestures could expand the techniques via which a user may interact with a computing device, conventional implementations of these techniques often did not address how a user interacted with a device to perform these gestures, which could be frustrating to a user as well as inefficient.

### SUMMARY

Bezel gesture techniques are described. In one or more implementations, a determination is made that an input involves detection of an object by one or more bezel sensors. The bezel sensors are associated with a display device of a computing device. A location is identified from the input that corresponds to the detection of the object and an item is displayed at a location on the display device that is based at least in part on the identified location.

In one or more implementations, a determination is made that an input involves detection of an object by one or more bezel sensors. The bezel sensors are associated with a display device of the computing device. A gesture is recognized that corresponds to the input and subsequent inputs are captured that are detected as part of the gesture such that those inputs are prevented from initiating another gesture until recognized completion of the gesture.

In one or more implementations, a computing device includes an external enclosure configured to be held by one or more hands of a user, a display device disposed in and secured by the external enclosure, one or more bezel sensors disposed adjacent to the display portion of the display device, and one or more modules implemented at least partially in hardware and disposed within the external enclosure. The display device includes one or more sensors configured to support touchscreen functionality and a display portion configured to output a display that is viewable by the user. The one or more modules are configured to determine that an input involves detection of an object by the one or more bezel sensors and cause display by the display device of an item at a location on the display device that is based at least in part on a location identified as corresponding to the detection of the object by the one or more bezel sensors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ gesture techniques.

FIG. 2 depicts a system showing bezel and display portions of a computing device of FIG. 1 in greater detail.

FIG. 3 depicts an example implementation in which a computing device in a mobile configuration is held by a user and outputs a user interface configured to support interaction when being held.

FIG. 4 depicts an example implementation showing first and second examples of an item configured to provide feedback to a user based on a gesture detected using bezel sensors of a bezel.

FIG. 5 depicts an example implementation showing first and second examples of a range of motion supported by a thumb of a user's hand when holding a computing device.

FIG. 6 depicts an example implementation in which a gesture is utilized to initiate output of an item at a location corresponding to the gesture and that is configured as an arc user interface control.

FIG. 7 depicts an example implementation showing additional examples of an arc user interface control.

FIG. 8 depicts an example implementation including first, second, and third examples of gesture interaction that leverages the bezel portion.

FIG. 9 depicts an example implementation showing examples of a user interface control that is usable to perform indirect interaction with elements display by a display device without a change in grip by one or more hands of a user.

FIG. 10 depicts an example of a simultaneous slide bezel gesture usable to display a split keyboard.

FIG. 11 depicts an example implementation showing capture techniques in relation to a bezel gesture.

FIG. 12 depicts an example implementation of a zig-zag bezel gesture.

FIG. 13 is an illustration of an example implementation showing a bezel gesture that is recognized as involving movement of an input as dragging upward on opposite sides of the display device.

FIGS. 14 and 15 are illustrations of an example of a thumb arc gesture.

FIG. 16 depicts an example implementation showing a hook gesture that involves detection by bezel and display portions of a display device of a computing device.

FIG. 17 depicts an example implementation showing a corner gesture that involves detection by a bezel portion of a display device of a computing device.

FIG. 18 depicts a procedure in an example implementation in which display of an item is based at least in part on identification of a location detected by one or more bezel sensors.

FIG. 19 depicts a procedure in an example implementation in which capture techniques are utilized as part of a bezel gesture.

FIG. 20 illustrates various components of an example device that can be implemented as any type of portable and/or computer device as described with reference to FIGS. 1-19 to implement embodiments of the gesture techniques described herein.

### DETAILED DESCRIPTION

Overview

Conventional techniques that were employed to support gestures were often limited in how the gestures were detected, were often static and thus did not address how the computing device was being used, and so on. Consequently, interaction with a computing device using conventional gestures could make initiation of corresponding operations of the computing device frustrating and inefficient, such as requiring a user to shift a grip on the computing device in a mobile configuration, cause inadvertent initiation of other functionality of the computing device (e.g., “hitting the wrong button”), and so forth.

Bezel gestures techniques are described herein. In one or more implementations, bezel sensors may be disposed adjacent to sensors used by a display device to support touchscreen functionality. For example, the bezel sensors may be configured to match a type of sensor used to support the touchscreen functionality, such as an extension to a capacitive grid of the display device, through incorporation of sensors on a housing of the computing device, and so on. In this way, objects may be detected as proximal to the bezel sensors to support detection and recognition of gestures.

Regardless of how implemented, the bezel sensors may be leveraged to support a wide variety of functionality. For example, the bezel sensors may be utilized to detect an object (e.g., a user's thumb) and cause output of an item on the display device adjacent to a location, at which, the object is detected. This may include output of feedback that follows detected movement of the object, output of a menu, an arc having user interface controls that are configured for interaction with a thumb of a user's hand, and so on. This may also be used to support use of a control (e.g., a virtual track pad) that may be utilized to control movement of a cursor, support “capture” techniques to reduce a likelihood of inadvertent initiation of an unwanted gesture, and so on. Further discussion of these and other gesture bezel techniques may be found in relation to the following sections.

In the following discussion, an example environment is first described that is operable to employ the gesture techniques described herein. Example illustrations of gestures and procedures involving the gestures are then described, which may be employed in the example environment as well as in other environments. Accordingly, the example environment is not limited to performing the example gestures and procedures. Likewise, the example procedures and gestures are not limited to implementation in the example environment.

Example Environment

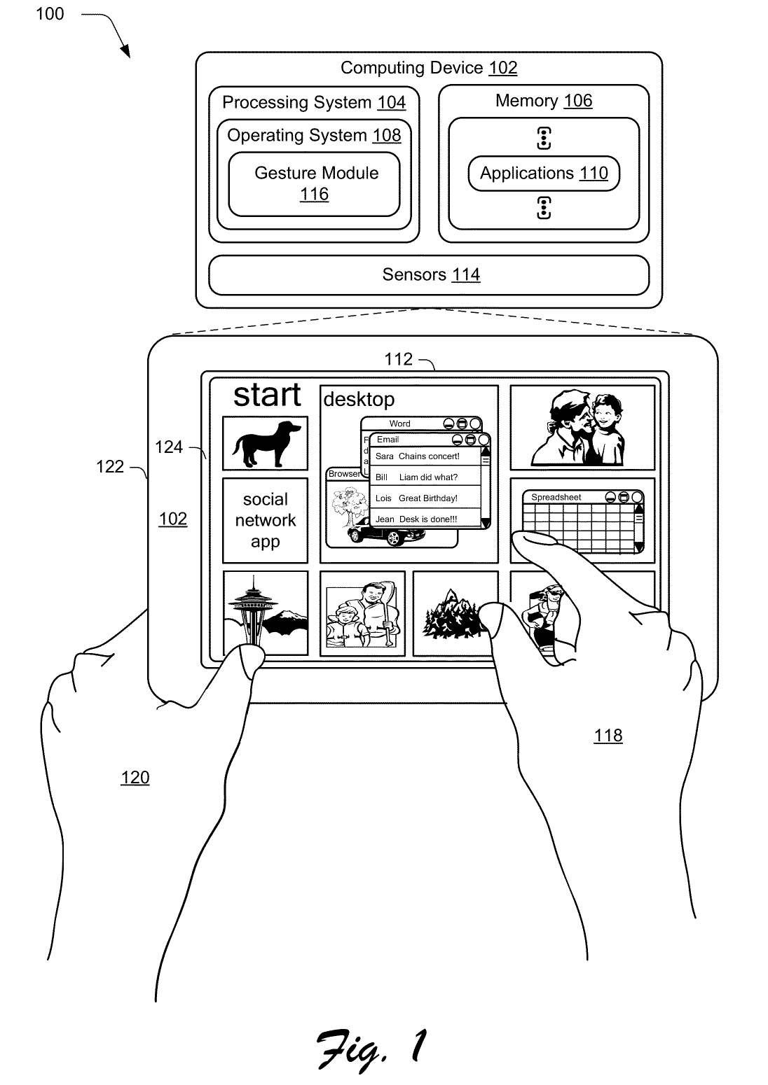

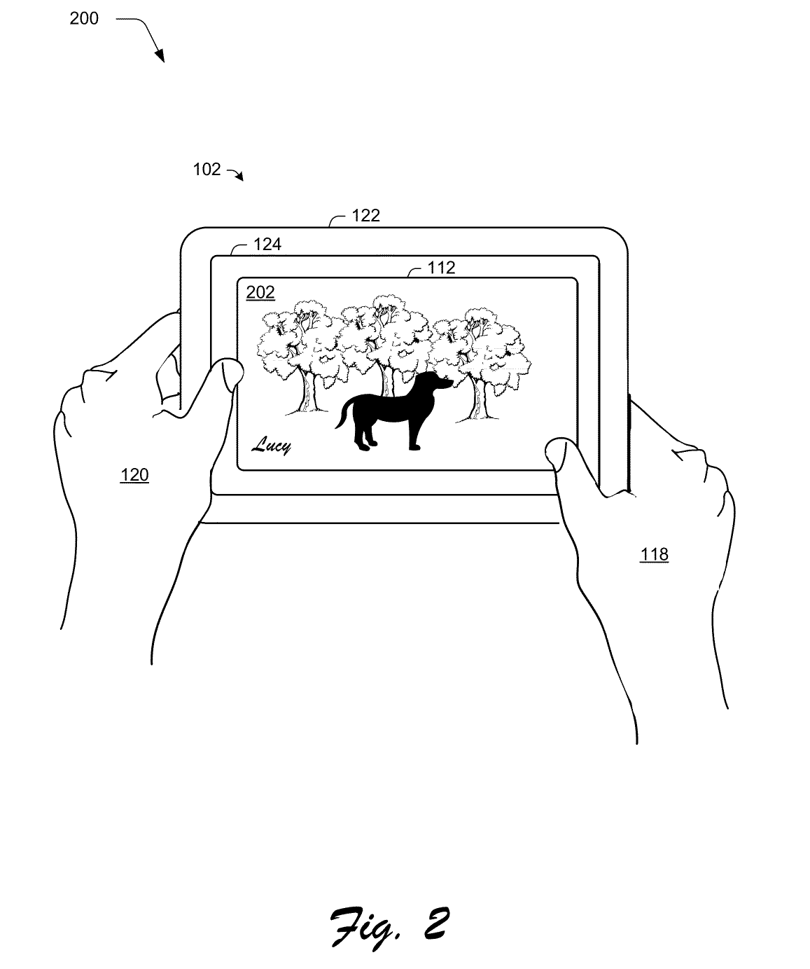

FIG. 1 is an illustration of an environment 100 in an example implementation that is operable to employ bezel gesture techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations. Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on.

The computing device 102 is further illustrated as including a processing system 104 and an example of a computer-readable storage medium, which is illustrated as memory 106 in this example. The processing system 104 is illustrated as executing an operating system 108. The operating system 108 is configured to abstract underlying functionality of the computing device 102 to applications 110 that are executable on the computing device 102. For example, the operating system 108 may abstract functionality of the processing system 104, memory, network functionality, display device 112 functionality, sensors 114 of the computing device 102, and so on. This may be performed such that the applications 110 may be written without knowing “how” this underlying functionality is implemented. The application 110, for instance, may provide data to the operating system 108 to be rendered and displayed by the display device 112 without understanding how this rendering will be performed.

The operating system 108 may also represent a variety of other functionality, such as to manage a file system and user interface that is navigable by a user of the computing device 102. An example of this is illustrated as a desktop that is displayed on the display device 112 of the computing device 102.

The operating system 108 is also illustrated as including a gesture module 116. The gesture module 116 is representative of functionality of the computing device 102 to recognize gestures and initiate performance of operations by the computing device responsive to this recognition. Although illustrated as part of an operating system 108, the gesture module 116 may be implemented in a variety of other ways, such as part of an application 110, as a stand-alone module, and so forth. Further, the gesture module 116 may be distributed across a network as part of a web service, an example of which is described in greater detail in relation to FIG. 20.

The gesture module 116 is representative of functionality to identify gestures and cause operations to be performed that correspond to the gestures. The gestures may be identified by the gesture module 116 in a variety of different ways. For example, the gesture module 116 may be configured to recognize a touch input, such as a finger of a user's hand 118 as proximal to a display device 112 of the computing device 102. In this example, the user's other hand 120 is illustrated as holding an external enclosure 122 (e.g., a housing) of the computing device 102 that is illustrated as having a mobile form factor configured to be held by one or more hands of the user as further described below.

The recognition may leverage detection performed using touchscreen functionality implemented in part using one or more sensors 114 to detect proximity of an object, e.g., the finger of the user's hand 118 in this example. The touch input may also be recognized as including attributes (e.g., movement, selection point, etc.) that are usable to differentiate the touch input from other touch inputs recognized by the gesture module 116. This differentiation may then serve as a basis to identify a gesture from the touch inputs and consequently an operation that is to be performed based on identification of the gesture.

For example, a finger of the user's hand 106 is illustrated as selecting a tile displayed by the display device 112. Selection of the tile and subsequent movement of the finger of the user's hand 118 may be recognized by the gesture module 116. During this selection, The gesture module 116 may then identify this recognized movement as indicating a “drag and drop” operation to change a location of the tile to a location on the display device 112 at which the finger of the user's hand 118 was lifted away from the display device 112, i.e., the recognized completion of the gesture. Thus, recognition of the touch input that describes selection of the tile, movement of the selection point to another location, and then lifting of the finger of the user's hand 118 may be used to identify a gesture (e.g., drag-and-drop gesture) that is to initiate the drag-and-drop operation.

A variety of different types of gestures may be recognized by the gesture module 116, such a gestures that are recognized from a single type of input (e.g., touch gestures such as the previously described drag-and-drop gesture) as well as gestures involving multiple types of inputs. For example, the computing device 102 may be configured to detect and differentiate between proximity to one or more sensors utilized to implement touchscreen functionality of the display device 112 from one or more bezel sensors utilized to detect proximity of an object at a bezel 124 of the display device 112. The differentiation may be performed in a variety of ways, such as by detecting a location at which the object is detected, use of different sensors, and so on.

Thus, the gesture module 116 may support a variety of different gesture techniques by recognizing and leveraging a division between inputs received via a display portion of the display device and a bezel 124 of the display device 112. Consequently, the combination of display and bezel inputs may serve as a basis to indicate a variety of different gestures. For instance, primitives of touch (e.g., tap, hold, two-finger hold, grab, cross, pinch, hand or finger postures, and so on) may be composed to create a space of intuitive and semantically rich gestures that are dependent on “where” these inputs are detected. It should be noted that by differentiating between display and bezel inputs, the number of gestures that are made possible by each of these inputs alone is also increased. For example, although the movements may be the same, different gestures (or different parameters to analogous commands) may be indicated using inputs detected via the display versus a bezel, further discussion of which may be found in the following and shown in a corresponding figure.

Although the following discussion may describe specific examples of inputs, in instances the types of inputs may be switched (e.g., display may be used to replace bezel inputs and vice versa) and even removed (e.g., both inputs may be provided using either portion) without departing from the spirit and scope of the discussion.

FIG. 2 depicts a system 200 showing a bezel and display portion of the computing device 102 of FIG. 1 in greater detail. In this example, a display portion 202 of the display device 112 is shown as display a user interface, which in this instance includes an image of a dog and trees. In this example, the computing device 102 is illustrated as employing an external enclosure 122 that is configured to support the display device 112 and contain one or more modules of the computing device 102, e.g., a gesture module 116, processing system 104, memory 106, sensors 114, and so forth. Other configurations are also contemplated, such as configuration as a stand-alone monitor, laptop computer, gaming device, and so on.

As previously described, the display device 112 may include touchscreen functionality, such as to detect proximity of an object using one or more sensors configured as capacitive sensors, resistive sensors, strain sensors, acoustics sensors, sensor in a pixel (SIP), image sensors, cameras, and so forth. The display portion 202 is illustrated as at least partially surrounded (completed surrounded in this example) by a bezel 124. The bezel 124 is configured such that a display of a user interface is not supported and is thus differentiated from the display portion 202 in this example. In other words, the bezel 124 is not configured to display a user interface in this example. Other examples are also contemplated, however, such as selective display using the bezel 124, e.g., to display one or more items responsive to a gesture as further described below.

The bezel 124 includes bezel sensors that are also configured to detect proximity of an object. This may be performed in a variety of ways, such as to include sensors that are similar to the sensors of the display portion 202, e.g., capacitive sensors, resistive sensors, strain sensors, acoustics sensors, sensor in a pixel (SIP), image sensors, cameras, and so forth. In another example, different types of sensors may be used for the bezel 124 (e.g., capacitive) than the display portion 202, e.g., sensor in a pixel (SIP).

Regardless of how implemented, through inclusion of the bezel sensors as part of the bezel 124, the bezel may also be configured to support touchscreen functionality. This may be leveraged to support a variety of different functionality. For example, a touch-sensitive bezel may be configured provide similar dynamic interactivity as the display portion 202 of the display device 112 by using portions of the display portion 202 adjacent to the bezel input for visual state communication. This may support increased functionality as the area directly under a user's touch is typically not viewed, e.g., by being obscured by a user's finger. Thus, while a touch-sensitive bezel does not increase the display area in this example, it may be used increase an interactive area supported by the display device 112.

Examples of such functionality that may leverage use of the bezel controls includes control of output of items based on detection of an object by a bezel which includes user interface control placement optimization, feedback, and arc user interface controls. Other examples include input isolation. Description of these examples may be found in corresponding sections in the following discussion, along with a discussion of examples of gestures that may leverage use of bezel sensors of the bezel 124.

Bezel Gestures and Item Display

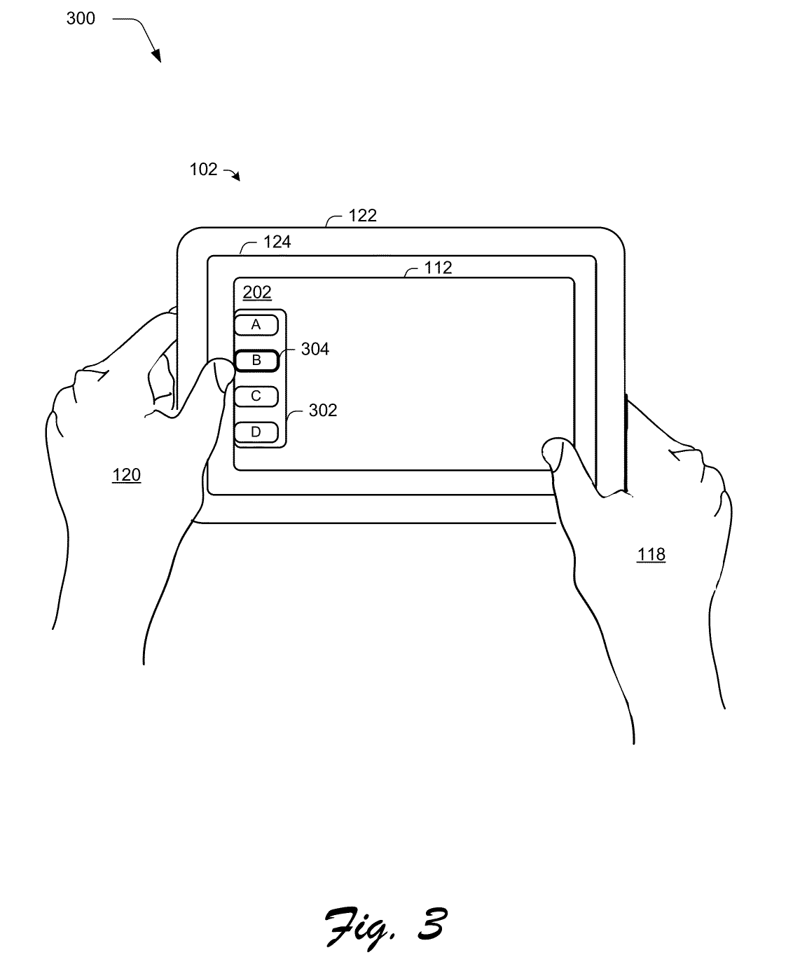

FIG. 3 depicts an example implementation 300 in which a computing device 102 in a mobile configuration is held by a user and outputs a user interface configured to support interaction when being held. Although users may hold the computing device 102 in a variety of ways, there are common ways which a user can simultaneously hold the computing device 102 and interact with touchscreen functionality of the device using the same hand that is gripping the device.

As illustrated, a user's hand 120 is shown as holding an external enclosure 122 of the computing device 102. A gesture may then be made using a thumb of the user's hand that begins in a bezel 124 of the computing device, and thus is detected using bezel sensors associated with the bezel 124. The gesture, for instance, may involve a drag motion disposed within the bezel 124.

In response, the gesture module 116 may recognize a gesture and cause output of an item at a location in the display portion 202 of the display device 112 that corresponds to a location in the bezel 124 at which the gesture was detected. In this way, the item is positioned near a location at which the gesture was performed and thus is readily accessible to the thumb of the user's hand 120.

Thus, the gesture indicates where the executing hand is located (based where the gesture occurs). In response to the bezel gesture, the item may be placed at the optimal location for the user's current hand position.

A variety of different items may be displayed in the display portion 202 based on a location of a gesture detected using bezel sensors of the bezel 124. In the illustrated example, a menu 302 is output proximal to the thumb of the user's hand 120 that includes a plurality of items that are selectable, which are illustrated as “A,” “B,” “C,” and “D.” This selection may be performed in a variety of ways. For example, a user may extend the thumb of the user's hand for detection using touchscreen functionality of the display portion 202.

A user may also make a selection by selecting an area (e.g., tapping) in the bezel 124 proximal to an item in the menu 302. Thus, in this example the bezel sensors of the bezel 124 may be utilized to extend an area via which a user may interact with items displayed in the display portion 202 of the display device 112.

Further, the gesture module 116 may be configured to output an item as feedback to aid a user in interaction with the bezel 124. In the illustrated example, for instance, focus given to the items in the menu may follow detected movement of the thumb of the user's hand 120 in the bezel 124. In this way, a user may view feedback regarding a location of the display portion 202 that corresponds to the bezel as well as what items are available for interaction by giving focus to those items. Other examples of feedback are also contemplated without departing from the spirit and scope thereof.

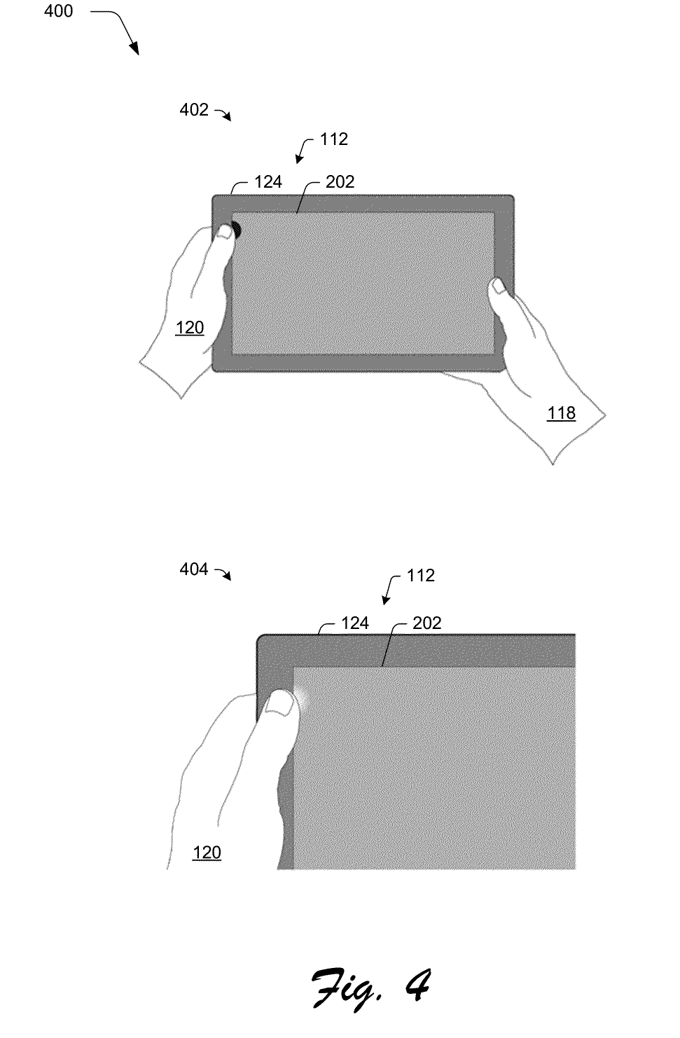

FIG. 4 depicts an example implementation 400 showing first and second examples 402, 404 of an item configured to provide feedback to a user based on a gesture detected using bezel sensors of a bezel. In the first example 402, a solid black half circle is displayed that is configured for display in the display portion 202 of the display device 112.

In the second example 404, the item is displayed as at least partially transparent such that a portion of a underlying user interface is displayable “through” the item. Thus, by making bezel feedback graphics partially transparent and layered on top of existing graphics in a user interface, it is possible to show feedback graphics without substantially obscuring existing application graphics.

The gesture module 116 may also incorporate techniques to control when the feedback is to be displayed. For example, to prevent bezel graphics utilized for the feedback from being too visually noisy or distracting, the item of may be shown in response to detected movement over a threshold speed, i.e., a minimum speed. For instance, a hand gripping the side of a device below this threshold would not cause display of bezel feedback graphics. However, movement above this threshold may be tracked to follow the movement. When the thumb movement slows to below the threshold, the bezel feedback graphic may fade out to be invisibility, may be maintained for a predefined amount of time (e.g., to be “ready” for subsequent movement), and so on.

Thus, the above examples describe techniques in which an item is displayed to support feedback. This may be used to shown acknowledgement of moving bezel input. Further measures may also be taken to communicate additional information. For example, graphics used as part of the item (e.g., the bezel cursor) may change color or texture during gesture recognition to communicate that a gesture is in the process of being recognized. Further, the item may be configured in a variety of other ways as previously described, an example of which is described as follows and shown in a corresponding figure.

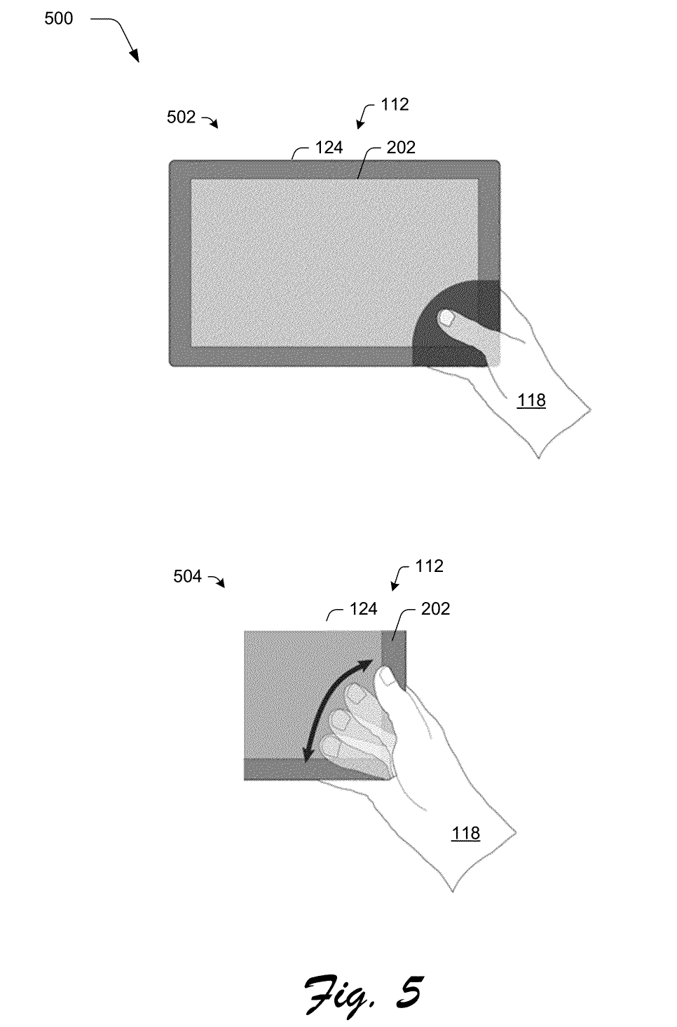

FIG. 5 depicts an example implementation 500 showing first and second examples of a range of motion supported by a thumb of a user's hand 118 when holding a computing device 102. The first and second examples 502, 504 show a range of motion that is available to a thumb of a user's hand 118 when griping the computing device 102. In other words, this is an example of a range of motion that is available to a user while holding the computing device 102 and without shifting of the user's hold on the device.

In the first example 502, for instance, the hand 118 grips the device at the lower right corner with the user's thumb being disposed over a display portion 202 and bezel of the device. In the figure, a darker quarter circle approximates the region that the user's thumb tip could easily reach while maintaining the same grip. In the second example 502, a natural motion of the thumb of the user's hand 118 is shown. This range, along with an indication of a location based on a gesture as detected using bezel sensors of the bezel, may also be utilized to configure an item for output in the display portion 202, an example of which is described as follows that involves an arc user interface control and is shown in a corresponding figure.

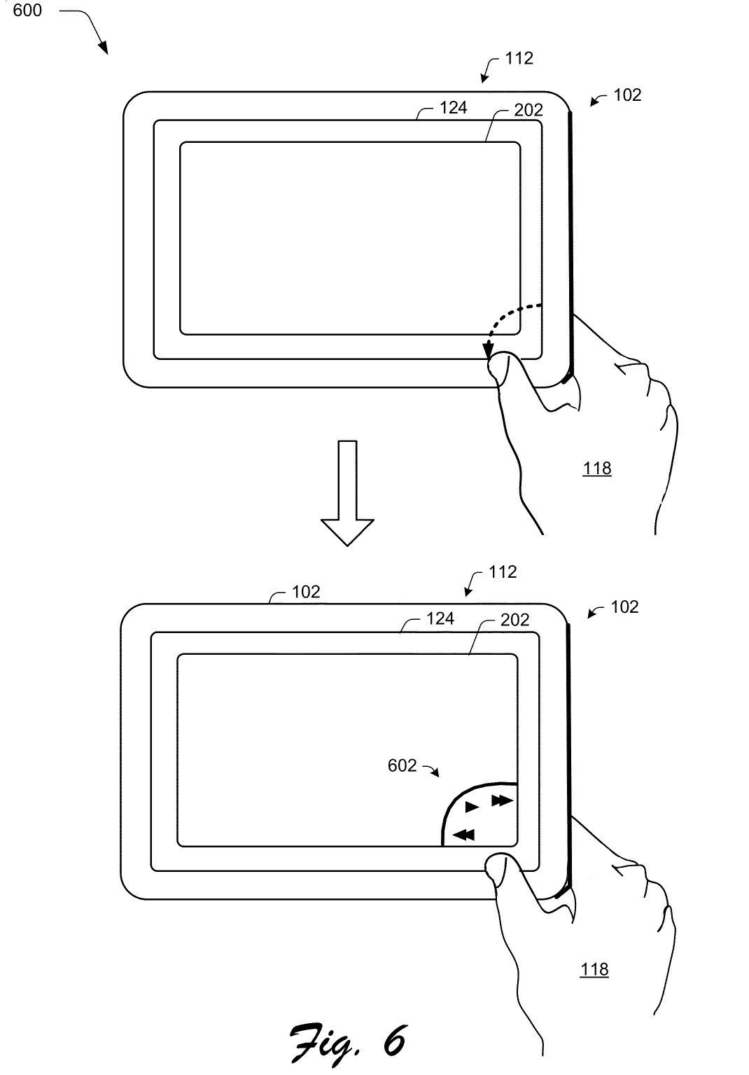

FIG. 6 depicts an example implementation 600 in which a gesture is utilized to initiate output of an item at a location corresponding to the gesture and that is configured as an arc user interface control. In this example, a gesture is detected that involves movement of a user's thumb. The gesture starts with a touch down over the right bezel, then crosses both the right and bottom display borders before being released at the bottom bezel. This gesture indicates a hand position at the lower right corner of the device. Other gestures are also contemplated, such as a gesture that is performed entirely within the bezel 124, i.e., detected solely by bezel sensors of the bezel 124.

In response to the gesture just described which indicates the corner grip, a control 602 optimized for the corner grip can be shown right where the hand 118 is most likely positioned. This can enable use of the control 602 while maintaining a comfortable grip. In the illustrated instance, the control 602 is configured to support control of output of media by the computing device 102.

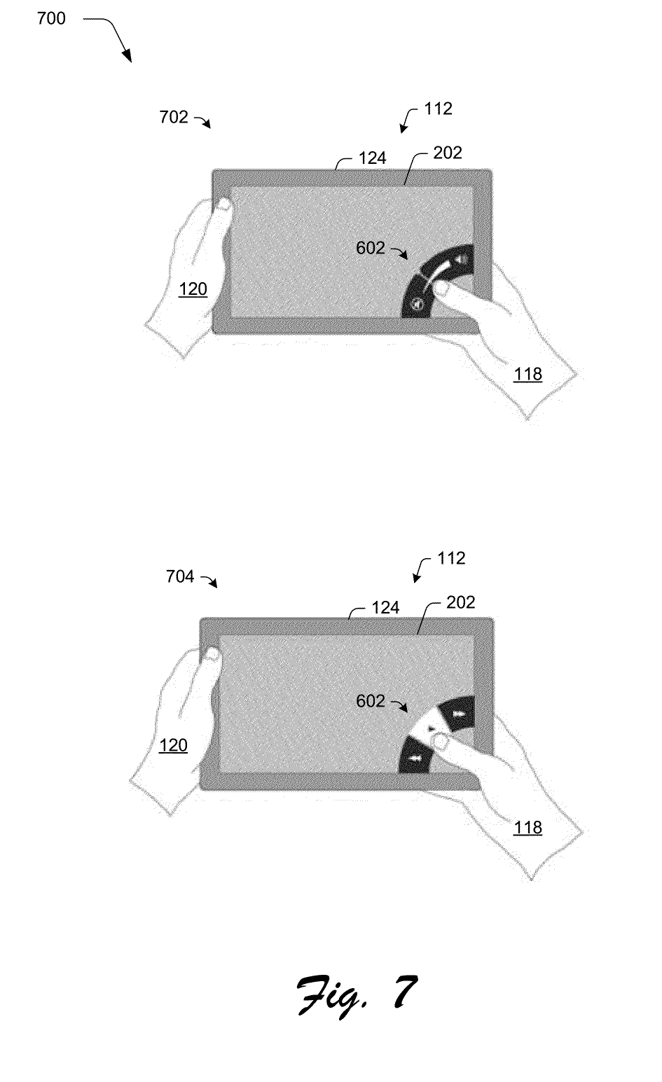

FIG. 7 depicts an example implementation 700 showing additional examples 702, 704 of an arc user interface control. In the first example 702, the control 602 is configured similar to a slider for controlling device volume. This control 602 is designed to be comfortable for use with a thumb while gripping the device at the corner. Resulting volume setting is based on the angle from the display corner to the tip of the thumb of the user's hand 118. This control's 602 functionality may be configured to be independent of or dependent on hand size, e.g., an arc defined by a space between a location of the gesture along the bezel 124 and a cornet of the bezel.

In the second example 704, a similar user interface control 602 for video playback is shown. Functionality of this control is similar to the volume control and may be optimized for the corner grip by the user's hand 118. The discrete options on the video playback control may be implemented as buttons or slider detents. Thus, a size and location of a control may be defined based at least in part on a location that corresponds to a gesture detected using bezel sensors of a bezel 124, additional examples of which are described as follows and shown in a corresponding figure.

FIG. 8 depicts an example implementation including first, second, and third examples 802, 804, 806 of gesture interaction that leverages the bezel 124. As shown in the first example 802, a user's hand 120 is utilized to hold the computing device at a location that is disposed generally at a middle of a side of the computing device 102. Accordingly, a range that may available to a thumb of the user's hand across the bezel 124 and display portion 202 may be greater that the range at the corner as described and shown in relation to FIG. 7 for a corner control.

Accordingly, the control 602 may be configured to take advantage of this increase is range. For example, the control 602 may be configured as a side arc user interface control. Although the side arc user interface control may be configured to function similarly to the corner arc control of FIG. 7, approximately 180 degrees of selection range may be supported, as opposed to approximately ninety degrees of selection range for the corner control. The selection range may be based on an angle from the center of the control at an edge of the display portion 202 and/or bezel 124 to a tip of a thumb of the user's hand 120. Just as these arc controls can work with hands of different sizes, the controls can also vary in size, with a smaller control being shown in the third example 806.

Additionally, a size of the control may also be based on whether the gesture module 114 determines that the computing device 102 is being held by a single hand or multiple hands. As shown in the second example 804, for instance, an increased range may also be supported by holding the computing device 102 using two hands 118, 120 as opposed to a range supported by holding the computing device 102 using a single hand 120 as shown in the third example 806. Thus, in this example size, position, and amount of functionality (e.g., a number of available menu items) may be based on how the computing device is held, which may be determined at least in part using the bezel sensors of the bezel 124. A variety of other configurations of the item output in response to the gesture are also contemplated, additional examples of which are described as follows and shown in a corresponding figure.

Indirect Interaction

On touchscreen devices, users are typically able to directly touch interactive elements without needing a cursor. Although direct touch has many benefits, there are also a few side effects. For example, fingers or other objects may obscure portions of the display device 112 beneath them and have no obvious center point. Additionally, larger interface elements are typically required to reduce the need for target visibility and touch accuracy. Further, direct touch often involves movement of the user's hands to reach each target, with the range of movement being dependent on the size of the screen and the position of targets.

Accordingly, techniques are described that support indirect interaction (e.g., displaced navigation) which alleviates the side-effects described above. Further, these techniques may be implemented without use of separate hardware such as a mouse or physical track pad.

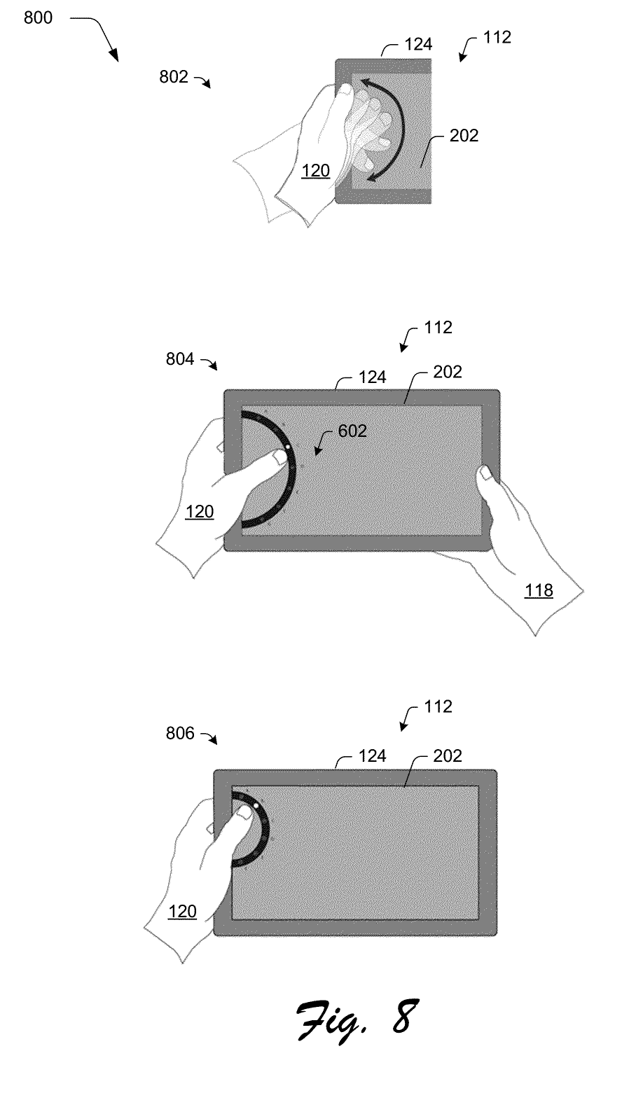

FIG. 9 depicts an example implementation 900 showing examples 902, 904 of a user interface control that is usable to perform indirect interaction with elements display by a display device 112 without a change in grip by one or more hands of a user. In the first example 902, a cursor is used to indicate interaction location, which is illustrated through use of two intersecting lines that indicate cursor position. It should be readily apparent, however, that a more typical arrow cursor may be used. Use of a cursor alleviates side-effects described above by not obscuring targets and providing visual feedback for the exact interaction point. In this way, smaller interactive elements may be displayed by the display device 112 and thus a number of elements may be increased, thereby promoting a user's efficiency in viewing and interacting with a user interface output by the display device 112.

A variety of different interaction modes may be utilized to control navigation of the cursor. For example, a relative mapping mode may be supported in which each touch and drag moves the cursor position relative to the cursor's position at the start of the drag. This functionality is similar to that of a physical track pad. Relative movement may be scaled uniformly (e.g., at 1:1, 2:1, and so on), or dynamically (e.g., fast movement is amplified at 4:1, slow movement enables more accuracy at 1:2). In this mode, tapping without dragging may initiate a tap action at the cursor location, buttons may be added to the control for left-click and right-click actions, and so on.

In another example, absolute mapping may be performed as shown in the second example 904. In this mode, a region 906 pictured in the lower right corner of the figure is a miniature map of a user interface output by the display device generally as a whole. While a user is manipulating a control 908 in the region 906, a cursor is placed at the equivalent point on the prominent portion of the user interface of the display device 112. Additionally, a tap input may be initiated response to a user's removal (e.g., lifting) of an input from the display device 112.

Thus, the control described here takes advantage of a mini-map concept to provide a user interface control for rapidly navigating among digital items (files and applications). This control is optimized for the corner grip and may be quickly summoned and used with the same hand, e.g., through use of a bezel gesture detected proximal to the area in the user interface at which the control 908 and region 906 are to be displayed.

The small squares shown in the region 906 in FIG. 9 represent files and applications. The squares are shown in groups. There are two groups present in the prominent view 910. In this example, the region 906 (e.g., mini-map) conveys that the prominent view 910 is a subsection of a larger context which includes eighteen total groups. The bounds of the prominent view 910 are represented in the region 906 by an orientation rectangle. The prominent view can easily be changed by touching and optionally dragging over the control 908 to move the orientation rectangle under the region 906 and the prominent view 910 are updated accordingly.

The grouping of items may be performed in a variety of ways, automatically and without user intervention or manually with user intervention. For example, groupings may be formed automatically based on frequency of use and item categories. A first group, for instance, may include the nine most recently opened applications, the next group may include the nine most recently opened files, the next groups could be partitioned by categories such as Social Media, Productivity, Photography, Games, and so forth.

Visual cues such as color coding and/or graphic patterns may also be employed to help users identify groups when viewed in the prominent 910 or smaller region 906 view, e.g., the mini-map. For example, the first group may represent items as blue squares on a light blue background. Because other groups have different square and background colors, a user can discover the location of this group quickly in the region 908.

Although this mode offers less accuracy than relative mode described in the first example 902, quicker interactions may be supported. Regardless of the mode of control selected, users may interact with other parts of the user interface displayed by the display device 112 while keeping their hand 118 in a comfortable position. This technique can work with a wide variety of screen sizes.

Split Keyboard Control

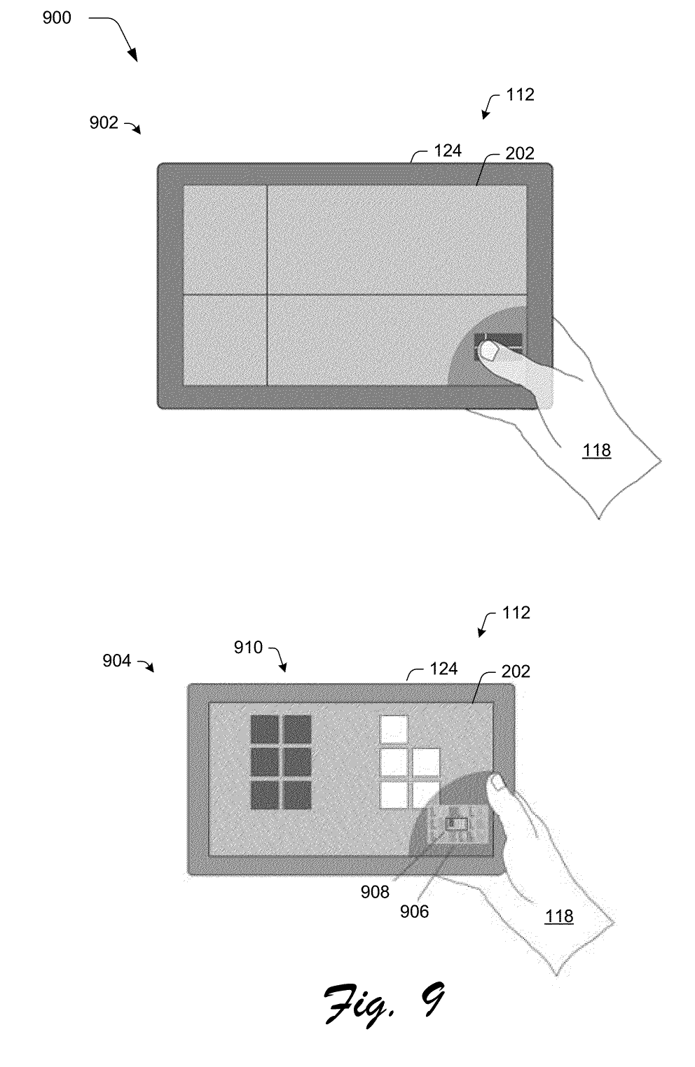

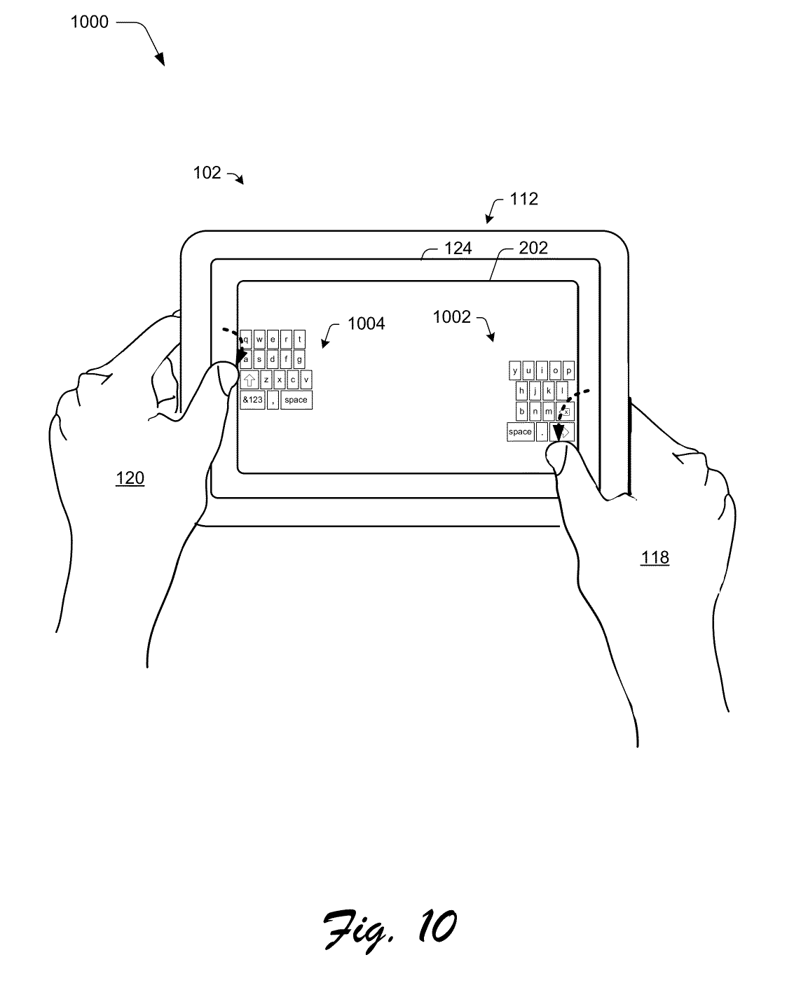

A variety of different types of controls may be output responsive to the bezel gestures techniques described herein. For example, consider the “Simultaneous Slide” multiple touch bezel gesture shown in the example implementation 1000 of FIG. 10. A bezel gesture is shown through the use of arrows that involves recognition of a selection is a bezel portion 124, which may or may not continue through the display portion 202 of the display device.

In response, a virtual keyboard is displayed on the display device 120 that include first and second portions 1002, 1004. Each of these portions 1002, 1004 are displayed on the display device based on where the bezel gesture was detected using the bezel portion 124. In this way, the portions 1002, 1004 may be positioned comfortably with respect to a user's hands 118, 120

FIG. 10 shows an example of a gesture that is usable to initiate this functionality through use of phantom lines. Each hand 118, 120 starts with a touch down over the bezel portion 124, then crosses a border into the display portion 202 before being released. Thus, this gesture indicates the position of both hands at the edges of the device.

In response to this gesture which indicates side grips, a control optimized for the side edge grip can be placed where the hands are most likely positioned, based on the location the gesture was executed. This can enable use of the new control while maintaining a comfortable grip. For example, the figure shows a split keyboard control which is placed at the correct screen position so minimal grip adjustment is involved in interacting with the portions 1002, 1004 of the keyboard.

In this example, the split keyboard may be dismissed by executing a similar gesture where each hand starts with a touch down over the display portion 202, and then crosses the border into the bezel portion 124 before being released. A variety of other examples are also contemplated without departing from the spirit and scope thereof.

Bezel Gesture Capture Techniques

FIG. 11 depicts an example implementation 1100 showing capture techniques in relation to a bezel gesture. In conventional devices, touch sensitivity is limited to the area over the display as previously described. As such, a “touch down” event (e.g., when a touch is initiated) caused outside the display region 202 is not sensed, so dragging from inside the display to outside results in recognition of a “touch up” event (e.g., when a touch input is terminated) as the touch input crosses a border from display portion 202 to the bezel portion 124. Similarly a touch dragged from outside the display portion 202 to inside results in recognition of a “touch down” event as the touch crosses the border from the bezel portion 124 to the display portion 202 in conventional techniques.

The additional functionality that bezel input provides may be useful, although it could be disruptive to existing applications that do not have code to support new behavior. In such instance, selective input isolation techniques may be employed to introduce touch input messages for input that occurs outside the display (e.g., the bezel portion 124) into current software frameworks in a manner the reduces and even eliminated disruption that may be cased.

For example, in selective input isolation an input may be classified based on whether it is inside or outside the border between the display portion 202 and bezel portion 124. Below is an example set of rules for delivering messages based on this classification.

For inputs that spend their lifespan entirely within the display portion 202, each of the messages are delivered to the applications by the operating system 108. For touches that spend their lifespan entirely outside the display portion 202 (e.g., in the bezel portion 124), no messages are delivered to applications 110, at least as normal touch messages. These bezel inputs may optionally be exposed via a different mechanism if desired.

For touches that start within the bezel portion 124 and are dragged inside to the display portion 124 as illustrated in FIG. 11, messages are delivered similarly as if no bezel input existed. As soon as the touch crosses the border, the operating system 108 may expose a “touch down” event to the applications 110.

For touches that start inside the border portion 124 or are dragged outside the border to the display portion 202, messages are delivered to the applications 110 for these touches even after being dragged outside the border. So it is possible for an application 110 to receive a “touch update” event (e.g., when properties of an input such as position are changed, several updates may occur during the lifetime of a touch) and a “touch up” event” for inputs that are over the bezel portion 124 as long as the same input at one point existed inside the bezel portion 124.

The above rules enable new interactions. For example, a touch interaction that starts a scroll interaction may continue the scroll interaction with the same input even after that input travels outside the display portion 202, e.g., scrolling may still track with touch movement that occurs over the bezel portion 124. Thus, inputs over the bezel portion 124 do not obscure a user interface displayed on the display portion 202.

Because touch interaction is conventionally limited to direct interaction over a display device, full-screen applications present an interesting challenge. Therefore, to support user initiation of system level interactions such as changing the active application either the active application supports touch interactivity to initiate system level commands or alternatively hardware sensors are provided to initiate the commands using conventional techniques.

Use of selective input isolation, however, may be used to enable bezel gestures are a solution to these challenges. A full-screen application 110 may maintain ownership of each input that occurs over the display portion 202, but the operating system 108 may still listen and react to bezel input gestures independently that are performed over the bezel portion 124. In this way, bezel input gestures can be utilized in a manger with increased flexibility over conventional hardware buttons as their meaning can be dynamic in that these gesture may have a location and many different gestures can be recognized.

Gesture Examples

Interactive touchscreen devices may support a wide range of dynamic activity, e.g., a single input may have different meanings based on the state of the application 110. This is made possible because the dynamic state of the application 110 is clearly displayed to the user on the display device 112 directly underneath the interactive surface, i.e., the sensors that detect the input. For example, a button graphic may be displayed to convey to the user that the region over the button will trigger an action when touched. When the user touches the button, the visual state may change to communicate to the user that their touch is acknowledged.

A bezel portion 124 that is configured to detect touch inputs can provide similar dynamic interactivity by using the display adjacent to the bezel input for visual state communication. Further, this may be performed with little to no loss of functionality as utilized by the display portion 202 as the area directly under a user's input (e.g., a touch by a finger of a user's hand 118) is typically not viewed anyway because it is obscured by the user's finger. While a touch-sensitive bezel does not increase the display area of the display device 112, it can increase the interactive area supported by the display device 112.

In addition, the border between display portion 202 and the bezel portion 124 may be made meaningful and useful for interpreting input. Following are descriptions for several techniques that take advantage of bezel input with adjacent display response and meaningful use of the border between display and bezel.

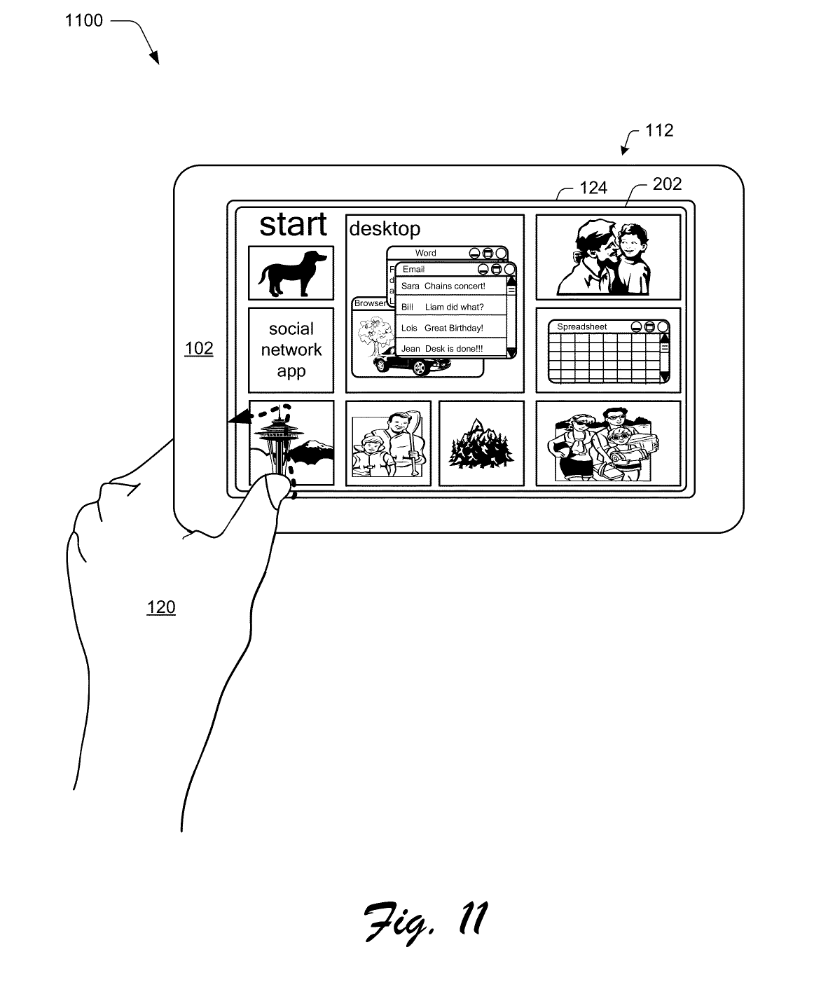

FIG. 12 depicts an example implementation 1200 of a zig-zag bezel gesture. As illustrated, the zig-zag gesture may be recognized as a simple “Z” pattern. Meaning may optionally be applied to orientation, direction, and/or location.

An example of the pattern that is recognizable as a gesture is described by the following steps. First, a touch down event is recognized. A drag input is recognized that involves movement over at least a predefined threshold. Another drag input is then recognized as involving movement in another direction approximately 180 degrees from the previous direction over at least a predefined threshold.

A further drag is then recognized as involvement movement in another direction approximately 180 degrees from the previous direction over at least a predefined threshold. A “touch up” event is then recognized from lifting of an object causing the input away from the sensors of the bezel portion 124.

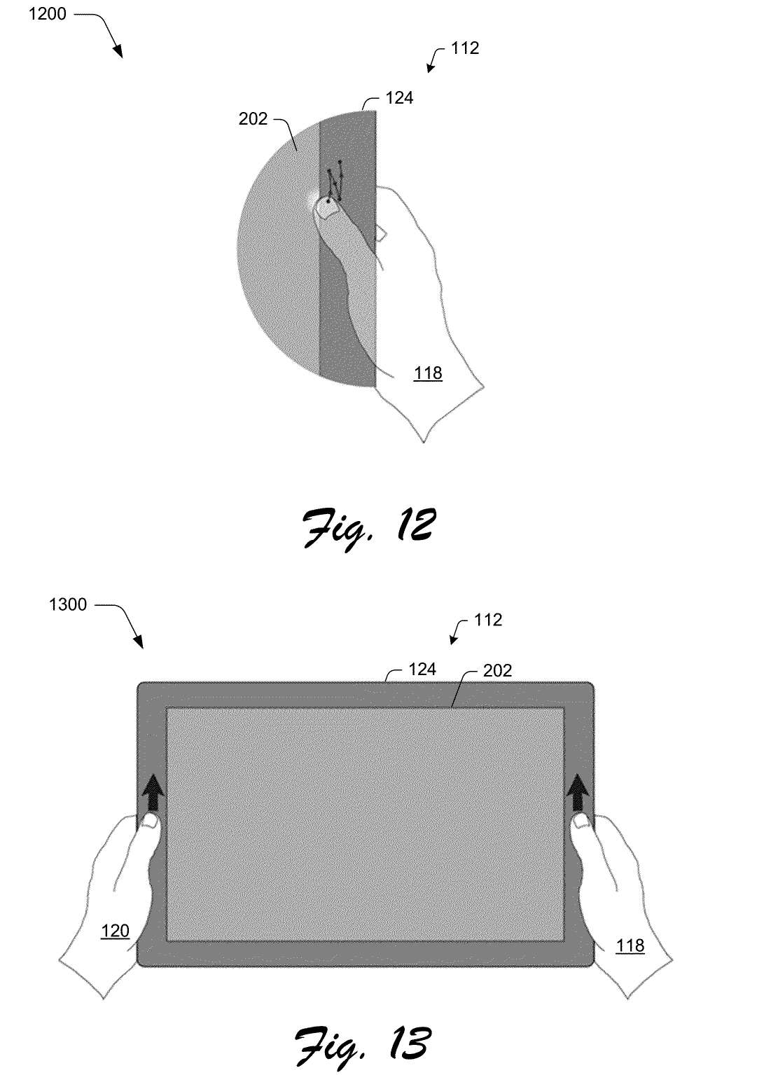

Patterns that are recognizable as bezel gestures may also involve simultaneous inputs from a plurality sources. An example implementation 1300 of which is shown in FIG. 13 in which a bezel gesture is recognized as involving movement of an input as dragging upward on opposite sides of the display device 112. In the illustrated example, this movement is made on opposing sides (e.g., both left and right sides) of the bezel portion 124 simultaneously.

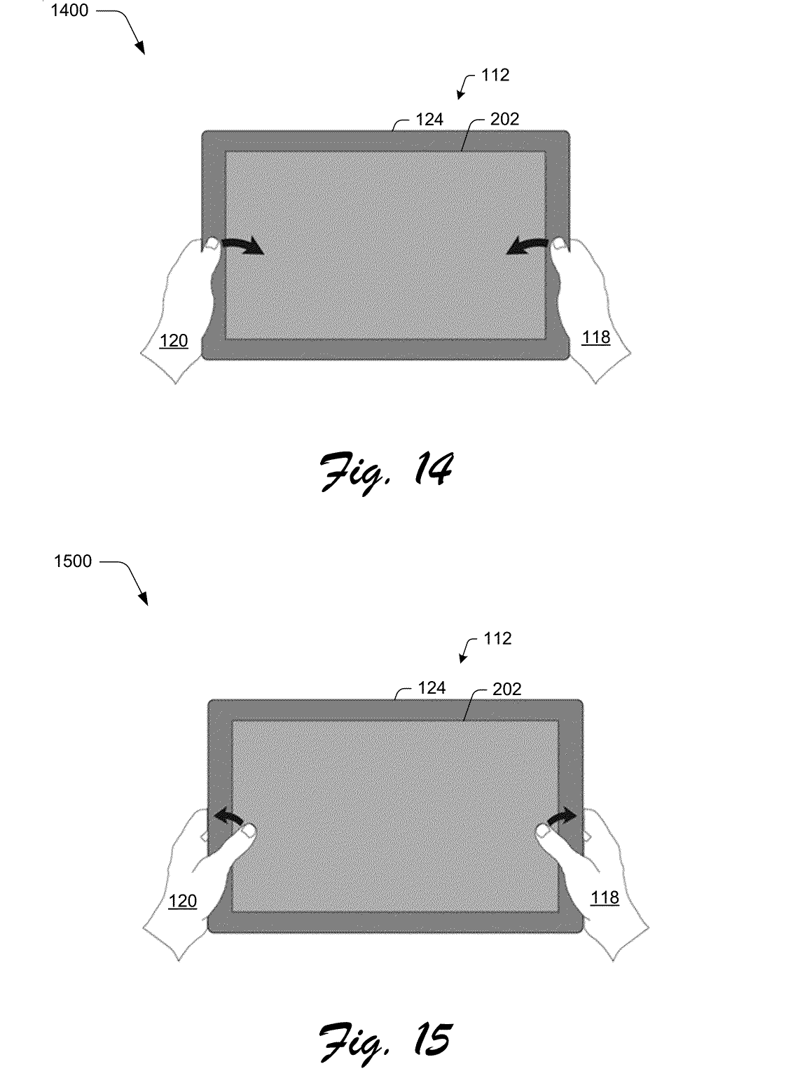

Bezel gesture recognizable patterns can also involve crossing a border between the display portion 202 and the bezel portion 124. As shown in the example implementations 1400, 1500 in FIGS. 14 and 15, for instance, a “thumb arc” gesture may be defined by the following steps executed within a predefined amount of time. First, a touch down on the bezel portion 124 may be recognized by fingers of a user's hands 118, 120 on opposing sides of the bezel portion 124.

Movement may then be recognized as continuing across a border between the bezel and display portions 124, 202, which subsequent movement continuing through the display portion 202. This may be recognized as a gesture to initiate a variety of different operations, such as display of the portions 1002, 1004 of the keyboard as described in FIG. 10. This gesture may also be reversed as shown in FIG. 15 to cease display of one or more of the portions 1002, 1004 of the keyboard of FIG. 10. A variety of other examples are also contemplated.

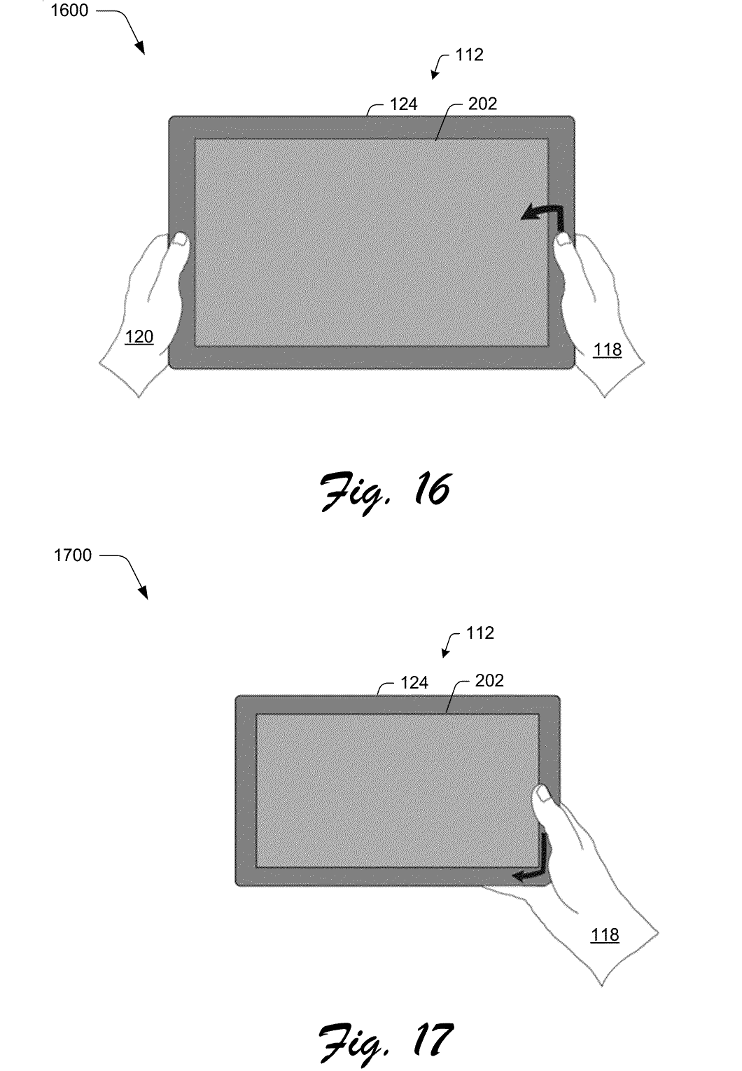

FIG. 16 depicts an example implementation 1600 showing a hook gesture that involves detection by bezel and display portions 124, 202 of a display device 112 of a computing device 102. In this example, a bezel portion 124 detect movement that occurs for at least a minimum predefined distance. This movement is then followed by crossing a border between the bezel and display portions 124, 202. As before, this may be utilized to initiate a wide variety of operations by the computing device 102, e.g., through recognition by the operating system 108, applications 110, and so forth.

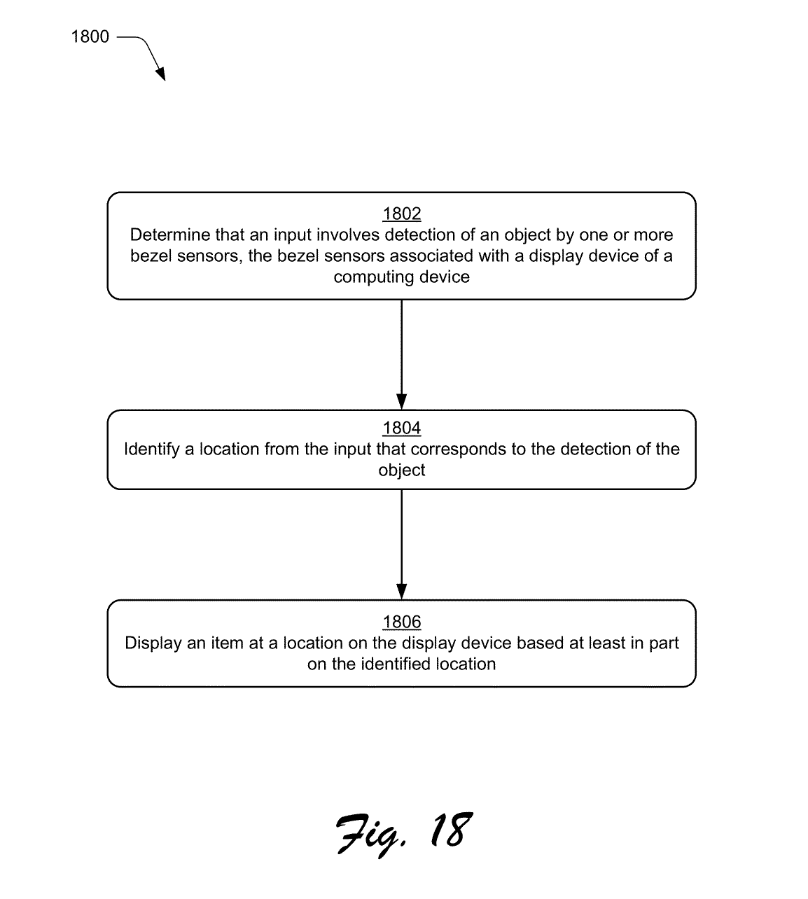

FIG. 17 depicts an example implementation 1700 showing a corner gesture that involves detection by a bezel portion 124 of a display device 112 of a computing device 102. In this example, the gesture is recognized as involving movement within the bezel 124 and not the display portion 202. As illustrated, a finger of a user's hand 118 may be utilized to make an “L” shape by touching down over a right side of the bezel portion 124 and continuing down and to the left to reach a bottom side of the bezel portion 124. Completion of the gesture may then be recognized by lifting the object being detected (e.g., the finger of the user's hand 118) away from the bezel portion 124.

A variety of other gestures are also contemplated. For example, double and triple tap gestures may also be recognized through interaction with the bezel portion 124. In some instance, a single tap may be considered as lacking sufficient complexity, as fingers gripping a hand-held device could frequently execute the involved steps unintentionally. Accordingly, a double-tap gesture may be recognized as involving two consecutive single tap gestures executed within a predefined physical distance and amount of time. Likewise, a triple-tap gesture may be recognized as involving three consecutive single tap gestures executed within a predefined physical distance and amount of time.

Example Procedures

The following discussion describes bezel gesture techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-17.

FIG. 18 depicts a procedure 1800 in an example implementation in which display of an item is based at least in part on identification of a location detected by one or more bezel sensors. A determination is made that an input involves detection of an object by one or more bezel sensors. The bezel sensors are associated with a display device of a computing device (block 1802). Bezel sensors located in a bezel portion 124 of a display device 112, for instance, may detect an object.

A location is identified from the input that corresponds to the detection of the object (block 1804) and an item is displayed at a location on the display device that is based at least in part on the identified location (block 1806). Continuing with the previous example, a gesture module 116 may make a determination as to a location that corresponds to the detection performed by the bezel sensors. An item, such as a control or other user interface element, may then be display based on this location, such as disposed in a display portion 202 as proximal to the detected location. This display may also be dependent on a variety of other factors, such as to determine as size of the item as shown in the arc menu example above.

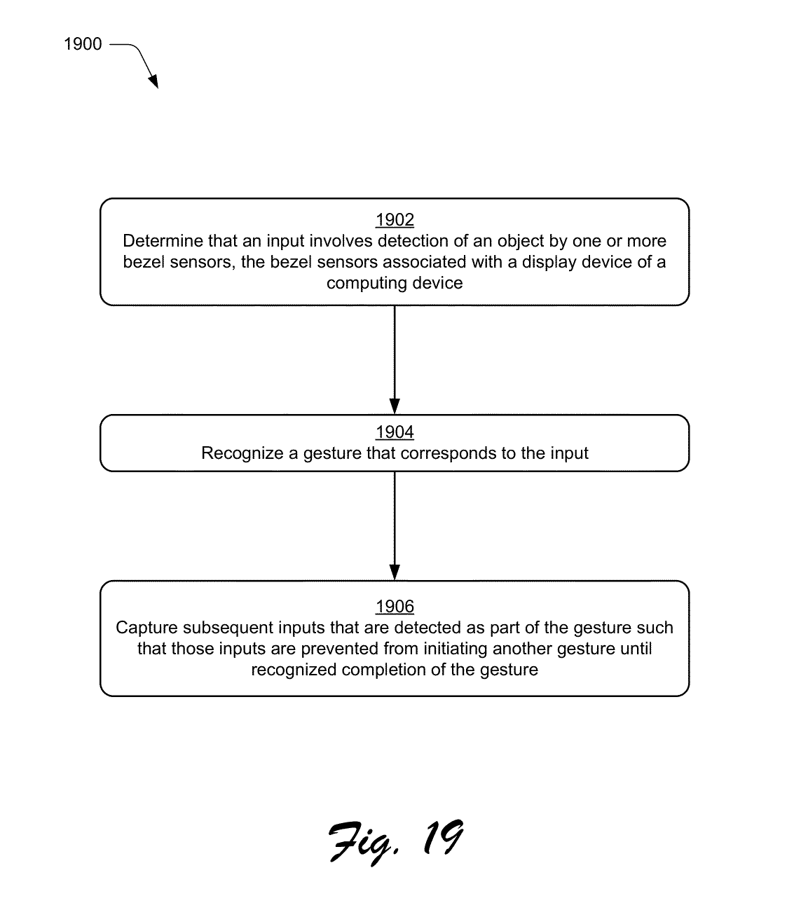

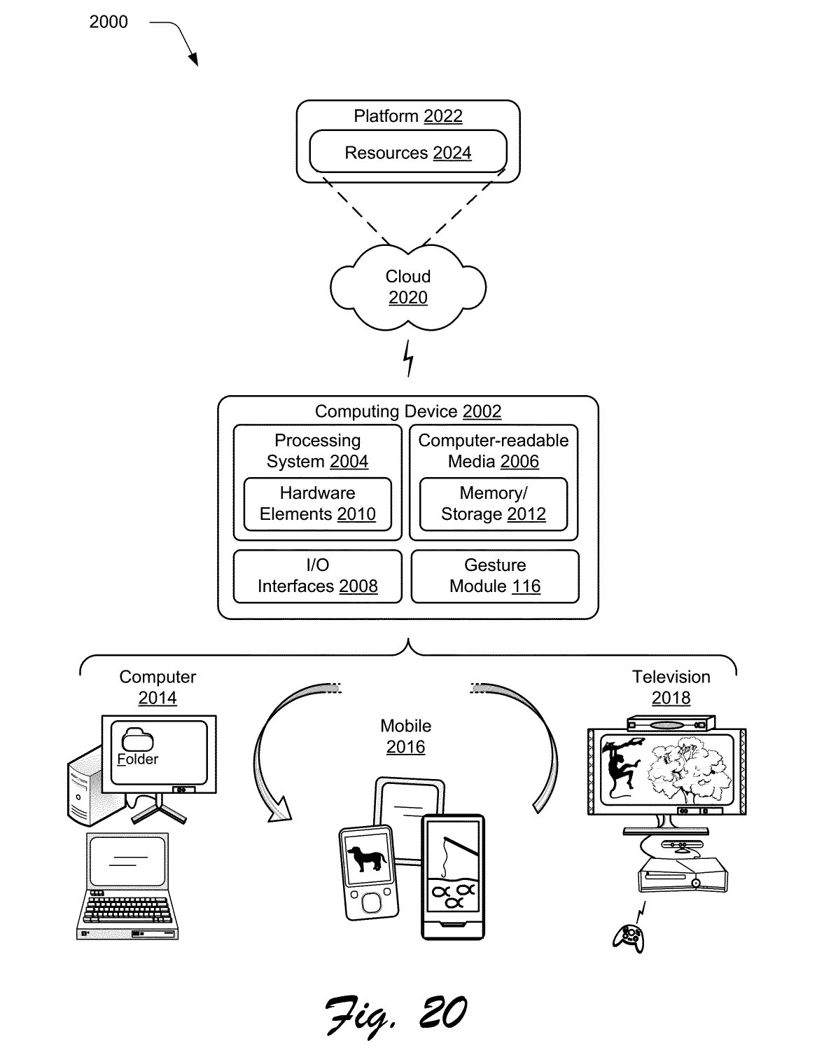

FIG. 19 depicts a procedure 1900 in an example implementation in which capture techniques are utilized as part of a bezel gesture. As before, a determination is made that an input involves detection of an object by one or more bezel sensors. The bezel sensors are associated with a display device of the computing device (block 1902). Like in FIG. 18 and as previously described, the bezel sensors may be configured in a variety of ways, such as capacitive, sensor in a pixel, flex, resistive, acoustic, thermal, and so on.

A gesture is recognized that corresponds to the input (block 1904) and subsequent inputs are captured that are detected as part of the gesture such that those inputs are prevented from initiating another gesture until recognized completion of the gesture (block 1906). The gesture module 116, for instance, may recognize a beginning of a gesture, such as movement, tap, and so on that is consistent with at least a part of a defined gesture that is recognizable by the gesture module 116. Subsequent inputs may then be captured until completion of the gesture. For instance, an application 110 and/or gesture module 116 may recognize interaction via gesture with a particular control (e.g., a slider) and prevent use of subsequent inputs that are a part of the gesture (e.g., to select items of the slider) from initiating another gesture. A variety of other examples are also contemplated as previously described.

Example System and Device

FIG. 20 illustrates an example system generally at 2000 that includes an example computing device 2002 that is representative of one or more computing systems and/or devices that may implement the various techniques described herein as shown through inclusion of the gesture module 116. The computing device 2002 may be, for example, a server of a service provider, a device associated with a client (e.g., a client device), an on-chip system, and/or any other suitable computing device or computing system.

The example computing device 2002 as illustrated includes a processing system 2004, one or more computer-readable media 2006, and one or more I/O interface 2008 that are communicatively coupled, one to another. Although not shown, the computing device 2002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2004 is representative of functionality to perform one or more operations using hardware. Accordingly, the processing system 2004 is illustrated as including hardware element 2010 that may be configured as processors, functional blocks, and so forth. This may include implementation in hardware as an application specific integrated circuit or other logic device formed using one or more semiconductors. The hardware elements 2010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2006 is illustrated as including memory/storage 2012. The memory/storage 2012 represents memory/storage capacity associated with one or more computer-readable media. The memory/storage component 2012 may include volatile media (such as random access memory (RAM)) and/or nonvolatile media (such as read only memory (ROM), Flash memory, optical disks, magnetic disks, and so forth). The memory/storage component 2012 may include fixed media (e.g., RAM, ROM, a fixed hard drive, and so on) as well as removable media (e.g., Flash memory, a removable hard drive, an optical disc, and so forth). The computer-readable media 2006 may be configured in a variety of other ways as further described below.

Input/output interface(s) 2008 are representative of functionality to allow a user to enter commands and information to computing device 2002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2010 and computer-readable media 2006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2010. The computing device 2002 may be configured to implement particular instructions and/or functions corresponding to the software and/or hardware modules. Accordingly, implementation of a module that is executable by the computing device 2002 as software may be achieved at least partially in hardware, e.g., through use of computer-readable storage media and/or hardware elements 2010 of the processing system 2004. The instructions and/or functions may be executable/operable by one or more articles of manufacture (for example, one or more computing devices 2002 and/or processing systems 2004) to implement techniques, modules, and examples described herein.

As further illustrated in FIG. 20, the example system 2000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 2000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 2002 may assume a variety of different configurations, such as for computer 2014, mobile 2016, and television 2018 uses. Each of these configurations includes devices that may have generally different constructs and capabilities, and thus the computing device 2002 may be configured according to one or more of the different device classes. For instance, the computing device 2002 may be implemented as the computer 2014 class of a device that includes a personal computer, desktop computer, a multi-screen computer, laptop computer, netbook, and so on.

The computing device 2002 may also be implemented as the mobile 2016 class of device that includes mobile devices, such as a mobile phone, portable music player, portable gaming device, a tablet computer, a multi-screen computer, and so on. The computing device 2002 may also be implemented as the television 2018 class of device that includes devices having or connected to generally larger screens in casual viewing environments. These devices include televisions, set-top boxes, gaming consoles, and so on.

The techniques described herein may be supported by these various configurations of the computing device 2002 and are not limited to the specific examples of the techniques described herein. This functionality may also be implemented all or in part through use of a distributed system, such as over a “cloud” 2020 via a platform 2022 as described below.

The cloud 2020 includes and/or is representative of a platform 2022 for resources 2024. The platform 2022 abstracts underlying functionality of hardware (e.g., servers) and software resources of the cloud 2020. The resources 2024 may include applications and/or data that can be utilized while computer processing is executed on servers that are remote from the computing device 2002. Resources 2024 can also include services provided over the Internet and/or through a subscriber network, such as a cellular or Wi-Fi network.

The platform 2022 may abstract resources and functions to connect the computing device 2002 with other computing devices. The platform 2022 may also serve to abstract scaling of resources to provide a corresponding level of scale to encountered demand for the resources 2024 that are implemented via the platform 2022. Accordingly, in an interconnected device embodiment, implementation of functionality described herein may be distributed throughout the system 2000. For example, the functionality may be implemented in part on the computing device 2002 as well as via the platform 2022 that abstracts the functionality of the cloud 2020.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
determining that an input involves detection of an object by one or more bezel sensors, the bezel sensors associated with a display device of a computing device;
identifying a location from the input that corresponds to the detection of the object; and
displaying an item at a location on the display device based at least in part on the identified location.

2. A method as described in claim 1, wherein the bezel sensors are formed as a continuation of a capacitive grid of the display device that is configured to support touchscreen functionality of the display device.

3. A method as described in claim 1, wherein no part of a display output by the display device is viewable through the bezel sensors.

4. A method as described in claim 1, wherein the bezel sensors substantially surround a display portion of the display device.

5. A method as described in claim 1, wherein the item is an arc user interface control, an item that is selectable by a user, a notification, or a menu.

6. A method as described in claim 1, wherein the item is configured as a control that is usable to control movement of a cursor, the movement being displaced from a location on the display device at which the control is displayed.

7. A method as described in claim 1, further comprising determining a likelihood that the detection of the object as proximal is associated with a gesture and wherein the displaying is performed responsive to a determination that the detection of the object is associated with a gesture.

8. A method as described in claim 7, wherein the item is configured to provide feedback to a user regarding the identified location.

9. A method as described in claim 7, wherein the feedback is provided such that the item is configured to follow movement of the object detected using the bezel sensors.

10. A method implemented by a computing device, the method comprising:
determining that an input involves detection of an object by one or more bezel sensors, the bezel sensors associated with a display device of the computing device;
recognizing a gesture that corresponds to the input; and
capturing subsequent inputs that are detected as part of the gesture such that those inputs are prevented from initiating another gesture until recognized completion of the gesture.

11. A method as described in claim 10, wherein no part of a display output by the display device is viewable through the bezel sensors.

12. A method as described in claim 10, wherein the subsequent inputs are detected using touchscreen functionality of the display device.

13. A method as described in claim 10, wherein the completion of the gesture is recognized through ceasing of detection of the object.

14. A computing device comprising:
an external enclosure configured to be held by one or more hands of a user;
a display device disposed in and secured by the external enclosure, the display device including one or more sensors configured to support touchscreen functionality and a display portion configured to output a display that is viewable by the user;
one or more bezel sensors disposed adjacent to the display portion of the display device; and
one or more modules implemented at least partially in hardware and disposed within the external enclosure, the one or more modules configured to determine that an input involves detection of an object by the one or more bezel sensors and cause display by the display device of an item at a location on the display device that is based at least in part on a location identified as corresponding to the detection of the object by the one or more bezel sensors.

15. A computing device as described in claim 14, wherein the bezel sensors are formed as a continuation of a capacitive grid of the display device that is configured to support touchscreen functionality of the display device.

16. A computing device as described in claim 14, wherein no part of a display output by the display device is viewable through the bezel sensors.

17. A computing device as described in claim 14, wherein the bezel sensors substantially surround the display portion of the display device.

18. A computing device as described in claim 14, wherein the external enclosure is configured to be held by one or more hands of a user in a manner consistent with a mobile phone or tablet computer.

19. A computing device as described in claim 14, wherein the one or more bezel sensors are configured to employ techniques to detect the object that match techniques employed by the one or more sensors of the display device that are configured to support touchscreen functionality.

20. A computing device as described in claim 14, wherein the item is configured as a control that is usable to control movement of a cursor, the movement being displaced from a location on the display device at which the control is displayed.
